(19) United States
(12) Patent Application Publication
(10) Pub. No.: US 2008/0168380 A1
(43) Pub. Date: Jul. 10, 2008

(54) SYSTEM AND METHOD FOR GENERATING A USER INTERFACE HAVING A CUSTOMIZED FUNCTION INDICIA

(76) Inventors: Marianne Kodimer, Huntington Beach, CA (US); Harpreet Singh, Orange, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 11/619,877

(22) Filed: Jan. 4, 2007

(51) Int. Cl. G06F 3/048

(52) U.S. Cl. 715/779

(57) ABSTRACT

The subject application is directed to a system and method for customizing a user interface for a document processing device. Data representing the document processing operations capable of being performed by the document processing device is first stored and used to generate indicia representing first level document processing operations on an associated user interface. Upon receipt of user selection data corresponding to a selected first level document processing operation, a set of second level document processing operations is isolated. Indicia representative of the second level document processing operations are then generated. User selection data representative of a second level document processing operation is then received. A customized indicia is then generated corresponding to the commencement of the first and second level document processing operations.

### BACKGROUND OF THE INVENTION

The subject application is directed to a system and method for generating a customized user interface. More particularly, the subject application is directed to a system and method for efficiently and effectively isolating one or more user-specified, preselected commonly used document functions or operations so as to be readily recognizable and available for use in future document processing operations. However, it is to be appreciated that the subject teachings are applicable to any user interface for which a customized display of a frequently used or readily accessible functionality selection is desirable.

Many devices currently employ user interfaces to allow for selection and control of devices, such as document processing devices. By way of example, many office machines, such as copiers, printers, scanners, or facsimile machines, as well as multifunction peripherals that include more than one of these functions, employ a keyboard and display or a touch screen display. Many document processing devices allow the user to select a preselected or preset group of operations. Data identifying the preset group of operations is stored in such a way that the preset group of operations may be accessed readily and easily by the user via the user interface. However, the process for selecting the preset group of operations is often difficult and time consuming. In addition, once a group of operations is chosen, the resultant indicator, such as a corresponding icon, often fails to provide an adequate mnemonic of associated functions.

In operation, the user must first select a graphical representation or icon to represent the preset group of operations. Typically, the user is presented with a default icon, randomly chosen icons, or a default list of available icons. For example, if the user desires to create a preset for scanning templates, the user must select an icon to represent such preset function on the user interface of the document processing device. In earlier systems, the user will be presented with a set of icons from which to choose that will include all template icons available for all template operations, regardless of the operations to be configured by the user. As such, the user must find the desired icon, which will often be used for other functions, or does not adequately indicate the associated functions.

Accordingly, there is a need for a system and method for easily generating a indicator that functions as a mnemonic for a customized functionality associated therewith.

### SUMMARY OF THE INVENTION

In accordance with the subject application, there is provided a system and method for customizing a user interface.

Further, in accordance with the subject application, there is provided a system and method for efficiently and effectively isolating one or more user-specified, preselected commonly used document functions or operations so as to be readily recognizable and available for use in future document processing operations.

Still further, in accordance with the subject application, there is provided a system and method for easily generating a indicator that functions as a mnemonic for a customized functionality associated therewith.

Still further, in accordance with the subject application, there is provided a system for customizing a user interface for a document processing device. The system comprises storage means adapted for storing function data representative of each of a plurality of document processing operations associated with a document processing device and a display generator, wherein the display generator includes means adapted for generating, on an associated user interface, indicia representative of each of a plurality of first level of document processing operations on an associated user interface in accordance with the function data. The system further comprises means adapted for receiving, from an associated user via the user interface, first document processing operation selection data representative of at least a selected one of the first level of document processing operations and means adapted for isolating a subset of second level document processing operations corresponding to received document processing operation selection data. The display generator of the system further includes means adapted for generating, on the user interface, indicia representative of each of the subset of secondary document processing operations. The system also includes means adapted for receiving, from an associated user via the user interface, second document processing selection data representative of at least a selected one of the second level of document processing operations. The display generator also includes means adapted for generating, on the user interface, a customized indicia corresponding to a commencement of a document processing operation including the selected first and second level document processing operations.

In one embodiment, the customized indicia includes a visual indication of the first and second level document processing operations.

In another embodiment, the system further comprises means adapted for receiving identification data representative of an identity of the associated user. In this embodiment, the display generator means further includes means adapted for generating a menu of document processing operations corresponding to received identification data, which menu includes the customized indicia.

In yet another embodiment, the customized indicia is comprised of an icon including a visual representation of the first and second level document processing operations.

Preferably, the first level of document processing operations includes at least one of copying, scanning, facsimile transmission, electronic mail, and electronic storage.

Preferably, the second level of document processing operations includes at least a zoom operation, simplex/duplex operation, paper orientation operation, template generation operation, and finishing operation. Preferably, the finishing operation includes at least one of stapling, binding and hole punching.

Still further in accordance with the subject application, there is provided a method for customizing a user interface for a document processing device.

Still other advantages, aspects and features of the subject application will become readily apparent to those skilled in the art from the following description wherein there is shown and described a preferred embodiment of this subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and description will be regarded as illustrative in nature and not as restrictive.

### BRIEF DESCRIPTION OF THE DRAWINGS

The subject application is described with reference to certain figures, including:

FIG. 1 is an overall diagram of the system for customizing a user interface for a document processing device according to the subject application;

FIG. 2 is a block diagram illustrating controller hardware for use in the system for customizing a user interface for a document processing device according to the subject application;

FIG. 3 is a functional block diagram illustrating the controller for use in the system for customizing a user interface for a document processing device according to the subject application;

FIG. 4 is a flowchart illustrating a method for customizing a user interface for a document processing device according to the subject application;

FIG. 5 is a flowchart illustrating a method for customizing a user interface for a document processing device according to the subject application;

FIG. 6 is a block diagram illustrating a template screen for use in customizing a user interface for a document processing device according to the subject application;

FIG. 7 is a block diagram illustrating a template screen for use in customizing a user interface for a document processing device according to the subject application; and

FIG. 8 is a block diagram illustrating a template screen for use in customizing a user interface for a document processing device according to the subject application.

### DETAILED DESCRIPTION OF THE PREFERRED EMBODIMENT

The subject application is directed to a system and method for customizing a user interface. In particular, the subject application is directed to a system and method for efficiently and effectively isolating one or more user-specified, preselected commonly used document functions or operations so as to be readily recognizable and available for use in future document processing operations. More particularly, the subject application is directed to a system and method for easily generating an indicator that functions as a mnemonic for a customized functionality associated therewith. Preferably, the subject application is directed to a system and method for customizing a user interface for a document processing device.

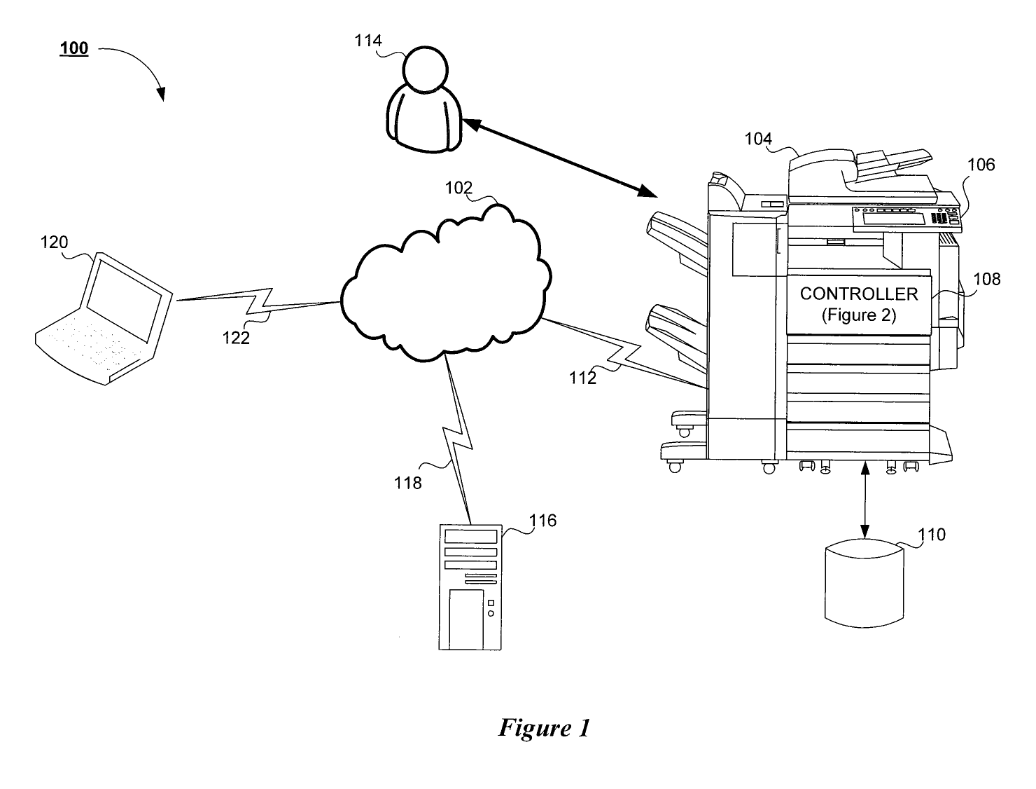

Referring now to FIG. 1, there is shown an overall diagram of the system 100 for customizing a user interface for a document processing device in accordance with the subject application. As shown in FIG. 1, the system 100 employs a distributed computing environment, illustrated as a computer network 102. It will be appreciated by those skilled in the art that the computer network 102 is any distributed communications environment known in the art capable of enabling the exchange of data between two or more electronic devices. The skilled artisan will further appreciate that the network 102 includes, for example and without limitation, a personal area network, a wide area network, a local area network, a virtual local area network, an intranet, the Internet, or the any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms.

The system 100 depicted in FIG. 1 further incorporates at least one document processing device 104, represented as a multifunction peripheral device, suitably adapted to perform a variety of document processing operations. The skilled artisan will understand that such document processing operations include, for example and without limitation, copying, scanning, electronic mail, document management, facsimile, printing, or the like. In addition thereto, the skilled artisan will appreciate that the document processing device 104 is further capable of providing a variety of document processing options, including, for example and without limitation, zoom operations, simplex/duplex operations, paper orientation operations, template generation operations, stapling, binding, hole punching, and other finishing options known in the art. Suitable commercially available document processing devices include, for example and without limitation, the Toshiba e-Studio Series Controller. In accordance with one aspect of the subject application, the document processing device 104 is suitably adapted to provide an associated user with the ability to customize the user interface associated with the document processing device 104. Preferably, the document processing device 104 includes hardware, software, and any suitable combination thereof, configured to interact with the associated user and provide such information thereupon.

In one embodiment, the document processing device 104 is suitably equipped to receive a plurality of portable storage media, including without limitation, Firewire drive, USB drive, SD, MMC, XD, Compact Flash, Memory Stick, and the like. In the preferred embodiment of the present invention, the document processing device 104 further includes an associated user-interface 106, such as a touch-screen interface, LCD display, or the like, via which an associated user 114 is able to interact directly with the document processing device 104. In accordance with the preferred embodiment of the subject application, the user-interface 106 is advantageously used to communicate information to the associated user 114 and receive selections from the associated user 114. Preferably, the document processing device 104 is communicatively coupled to the computer network 102 via a suitable communications link 112. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art.

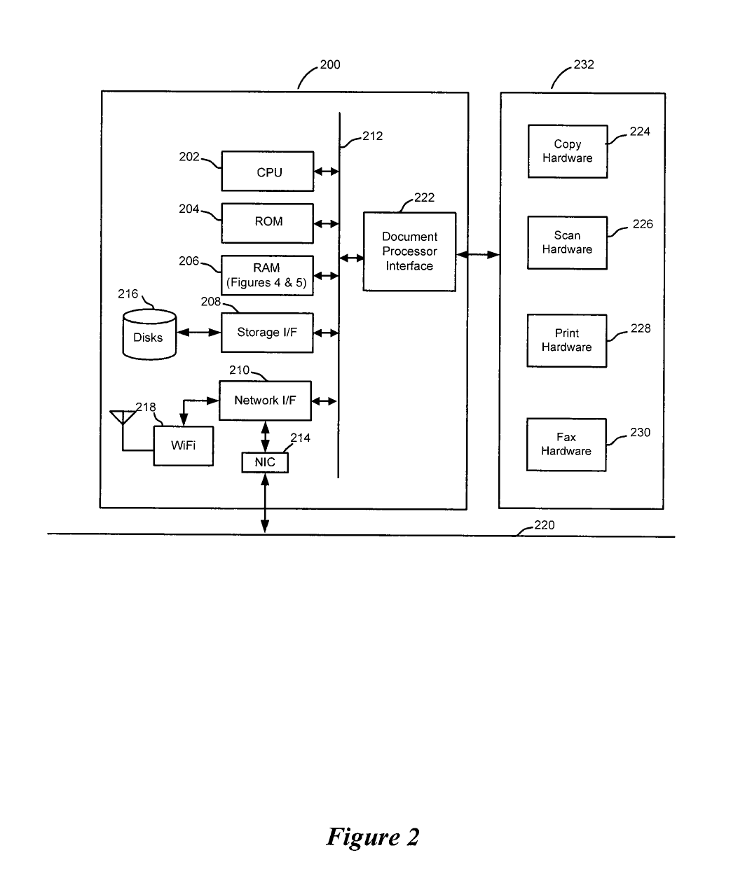

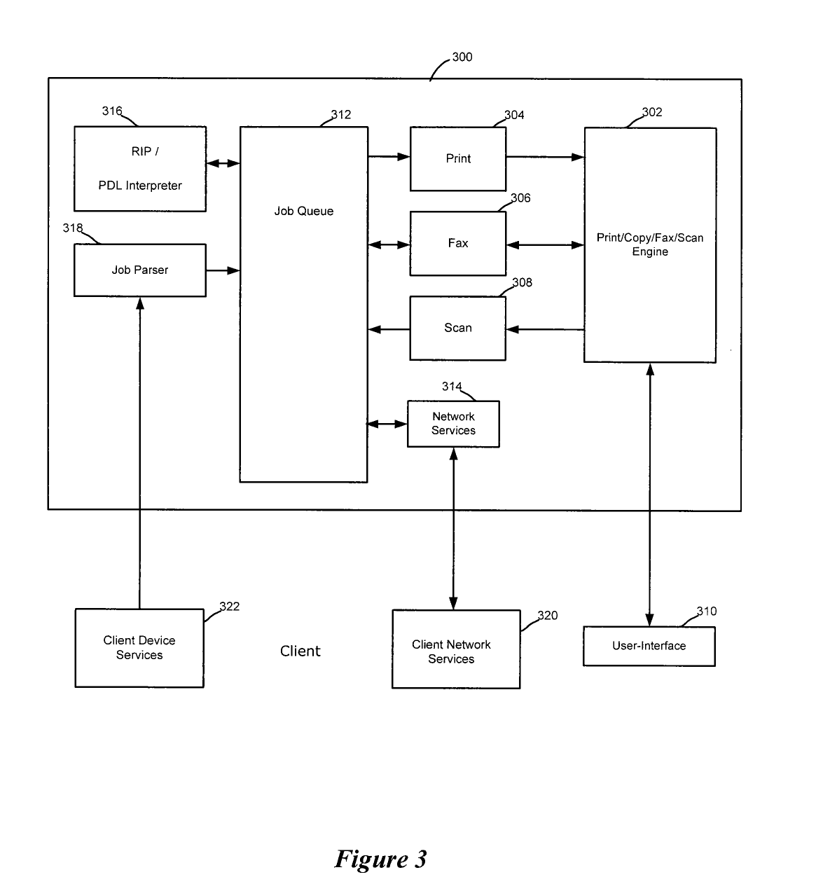

In accordance with the subject application, the document processing device 104 further incorporates a controller 108, suitably adapted to facilitate the operations of the first document processing device 104, as will be understood by those skilled in the art. Preferably, the controller 108 is embodied as hardware, software, or any suitable combination thereof, configured to control the operations of the associated document processing device 104, control the display of images via the user-interface 106, and the like. For purposes of explanation, the controller 108 is used to refer to any myriad of components associated with the document processing device 104, including hardware, software, or combinations thereof, functioning to perform, cause to be performed, control, or otherwise direct the methodologies described hereinafter. The functioning of the controller 108 will better be understood in conjunction with the block diagrams illustrated in FIGS. 2 and 3, explained in greater detail below.

Communicatively coupled to the document processing device 104 is a data storage device 110. In accordance with the preferred embodiment of the subject application, the data storage device 110 is any mass storage device known in the art including, for example and without limitation, magnetic storage drives, a hard disk drive, optical storage devices, flash memory devices, or any suitable combination thereof. In the preferred embodiment, the data storage device 110 is suitably adapted to store information relative to customized user interfaces associated with a plurality of users. That is, the data storage device 110 is suitably adapted to store one or more indicia representative of a document processing operation and related features in association with the particular user 114. As used herein, the skilled artisan will appreciate that the indicia is capable of including for example, and without limitation, data representative of an icon, a graphical representation, or the like, suitably adapted to denote a given operation or series of operations. Preferably, the data storage device 110 stores associations between user identification data and indicia, as will be explained in greater detail below. It will be appreciated by those skilled in the art that while illustrated in FIG. 1 as being a separate component of the system 100, the data storage device 110 is capable of being implemented as internal storage of the document processing device 104, a component of the controller 108, or the like, such as, for example and without limitation, an internal hard disk drive, or the like.

The system 100 further includes a network storage device, illustrated in FIG. 1 as a storage server 116. The storage server 116 is communicatively coupled to the computer network 102 via a suitable communications link 118. As will be understood by those skilled in the art, the communications link 118 is any communications means known in the art capable of enabling the exchange of data between two or more electronic devices. Suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art. The skilled artisan will understand that the storage server 116 is capable of providing network data storage services to the user 114, the document processing device 104, or a suitable user device 120, shown in FIG. 1 as a laptop computer. In accordance with one embodiment of the subject application, the storage server 116 is suitably adapted to store user identification data, electronic documents, provide electronic document management services, function as a database, or other document processing and management services, as are known in the art.

The user device 120 is in data communication with the computer network 102 via a suitable communications link 122. It will be appreciated by those skilled in the art that the user device 120 is depicted in FIG. 1 as a laptop computer for illustration purposes only. As the skilled artisan will understand, the user device 120 shown in FIG. 1 is representative of any personal computing device known in the art, including, for example and without limitation, a computer workstation, a personal computer, a personal data assistant, a web-enabled cellular telephone, a smart phone, or other web-enabled electronic device. The communications link 122 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. Preferably, the user device 120 is suitably adapted to generate and transmit electronic documents, as well as document processing instructions, to the document processing device 104, or any other similar device coupled to the computer network 102.

Turning now to FIG. 2, illustrated is a representative architecture of a suitable controller 200, shown in FIG. 1 as the controller 108, on which operations of the subject system 100 are completed. Included is a processor 202, suitably comprised of a central processor unit. However, it will be appreciated that processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the controller 200.

Also included in the controller 200 is random access memory 206, suitably formed of dynamic random access memory, static random access memory, or any other suitable, addressable and writable memory system. Random access memory provides a storage area for data instructions associated with applications and data handling accomplished by processor 202.

A storage interface 208 suitably provides a mechanism for non-volatile, bulk or long term storage of data associated with the controller 200. The storage interface 208 suitably uses bulk storage, such as any suitable addressable or serial storage, such as a disk, optical, tape drive and the like as shown as 216, illustrated in FIG. 1 as the storage device 110, as well as any suitable storage medium as will be appreciated by one of ordinary skill in the art.

A network interface subsystem 210 suitably routes input and output from an associated network allowing the controller 200 to communicate to other devices. Network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 214 is interconnected for data interchange via a physical network 220, suitably comprised of a local area network, wide area network, or a combination thereof.

Data communication between the processor 202, read only memory 204, random access memory 206, storage interface 208 and network interface subsystem 210 is suitably accomplished via a bus data transfer mechanism, such as illustrated by bus 212.

Also in data communication with bus 212 is a document processor interface 222. Document processor interface 222 suitably provides connection with hardware 232 to perform one or more document processing operations. Such operations include copying accomplished via copy hardware 224, scanning accomplished via scan hardware 226, printing accomplished via print hardware 228, and facsimile communication accomplished via facsimile hardware 230. It is to be appreciated that a controller suitably operates any or all of the aforementioned document processing operations. Systems accomplishing more than one document processing operation are commonly referred to as multifunction peripherals or multifunction devices.

Functionality of the subject system 100 is accomplished on a suitable document processing device that includes the controller 200 of FIG. 2, (shown in FIG. 1 as the controller 108), as an intelligent subsystem associated with a document processing device. In the illustration of FIG. 3, controller function 300 in the preferred embodiment, includes a document processing engine 302. A suitable controller functionality is that incorporated into the Toshiba e-Studio system in the preferred embodiment. FIG. 3 illustrates suitable functionality of the hardware of FIG. 2 in connection with software and operating system functionality as will be appreciated by one of ordinary skill in the art.

In the preferred embodiment, the engine 302 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that are subset of the document processing operations listed above.

The engine 302 is suitably interfaced to a user interface panel 310, which panel allows for a user or administrator to access functionality controlled by the engine 302. Access is suitably via an interface local to the controller, or remotely via a remote thin or thick client.

The engine 302 is in data communication with printer function 304, facsimile function 306, and scan function 308. These devices facilitate the actual operation of printing, facsimile transmission and reception, and document scanning for use in securing document images for copying or generating electronic versions.

A job queue 312 is suitably in data communication with printer function 304, facsimile function 306, and scan function 308. It will be appreciated that various image forms, such as bit map, page description language or vector format, and the like, are suitably relayed from scan function 308 for subsequent handling via job queue 312.

The job queue 312 is also in data communication with network services 314. In a preferred embodiment, job control, status data, or electronic document data is exchanged between job queue 312 and network services 314. Thus, suitable interface is provided for network based access to the controller 300 via client side network services 320, which is any suitable thin or thick client. In the preferred embodiment, the web services access is suitably accomplished via a hypertext transfer protocol, file transfer protocol, uniform data diagram protocol, or any other suitable exchange mechanism. Network services 314 also advantageously supplies data interchange with client side services 320 for communication via FTP, electronic mail, TELNET, or the like. Thus, the controller function 300 facilitates output or receipt of electronic document and user information via various network access mechanisms.

Job queue 312 is also advantageously placed in data communication with an image processor 316. Image processor 316 is suitably a raster image process, page description language interpreter or any suitable mechanism for interchange of an electronic document to a format better suited for interchange with device services such as printing 304, facsimile 306 or scanning 308.

Finally, job queue 312 is in data communication with a parser 318, which parser suitably functions to receive print job language files from an external device, such as client device services 322. Client device services 322 suitably include printing, facsimile transmission, or other suitable input of an electronic document for which handling by the controller function 300 is advantageous. Parser 318 functions to interpret a received electronic document file and relay it to a job queue 312 for handling in connection with the afore-described functionality and components.

In operation, the controller 108 associated with the document processing device 104 stores data representative of the document processing functions associated with the document processing device 104. Preferably, the document processing functions are capable of including, for example and without limitation, printing, scanning, copying, facsimile operations, electronic mail operations, electronic storage operations, or the like. The controller 108 then provides instructions to a display generator, which then generates on the associated user interface 106 indicia representative of each first level document processing operation in accordance with the function data. It will be understood by those skilled in the art that the controller 108 is capable of functioning in the role of the display generator, thereby facilitating the generation of indicia on the associated user interface 106. The skilled artisan will appreciate that the controller 108 advantageously controls the generation of an icon, or other graphical representation, associated with the first level document processing operations capable of being performed by the document processing device 104. As the skilled artisan will appreciate, the first level document processing operations include, for example and without limitation, a scanning operation, a printing operation, a copying operation, a facsimile operation, an electronic mail operation, an electronic storage operation, or the like.

The user 114 then selects, via the user interface 106, a desired first level document processing operation. The controller 108 then isolates a subset of document processing features, functions, operations, or the like, associated with the selected first level operation. For example, when the user selects a first level operation of copying a document, the controller 108 directs the gathering of a corresponding subset of features, such as zoom, duplex, finishing, or the like. The controller 108 then generates indicia, graphical representations, icons, or the like, corresponding to this second level of document processing operations on the associated user interface 106. The skilled artisan will appreciate that suitable second level document processing operations are capable of including, for example and without limitation, simplex/duplex operations, zoom operations, finishing operations, template generation operations, paper orientation operations, or the like. The user 114, via the associated user interface 106, then selects a desired second level document processing operation, whereupon the controller generates a customized indicia corresponding to the commencement of the first and second document processing operations.

In accordance with one embodiment of the subject application, the user device 120 is capable of providing the user 114 with remote access to the document processing device 104. In such an embodiment, the user 114, via the user device 120, selects the first level document processing operation and any second level operations. Using the computer network 102, the user device 120 transmits the user selection data to the document processing device 104 for further operations in accordance with the methodologies described herein. For example, the first level operation is capable of including a document printing operation, wherein the second level operation includes a document retrieval operation from the network server 116. Such user selections, both of the first and second level operations are initiated remotely by the user 114 via the user device 120. A customized indicia is then generated corresponding to the commencement of the first and second document processing operations.

In a further example of the subject application, data corresponding to the document processing functions, or operations, capable of being performed by the document processing device 104 is stored in the associated data storage device 110. The user 114 then inputs, via the associated user interface 106, identification data corresponding to the identity of the user 114. The skilled artisan will appreciate that such identification data includes, for example and without limitation, a password, a userID/password, biometric data, a smart card, a personal identification number (PIN number), or the like. In one embodiment of the subject application, the controller 108 uses the received identification data to verify the identity of the user 114 and ascertain any rights and privileges, or restrictions, associated therewith. In the instant example embodiment, the controller 108 uses the received identification data to determine whether any customized indicia has been previously generated and stored for the associated user 114. That is, the controller 108 searches the data storage device 110 for any customized indicia stored thereon in association with the user 114 as identified by the identification. When such customized indicia is available, the controller 108 retrieves the indicia from the data storage device 110 and generates a menu of document processing operations including the customized indicia. Stated another way, the indicia, which is representative of a preselected first level and second level document processing operations, is displayed on a menu depicted by a graphical user interface.

Irrespective of whether previously generated customized indicia are available, the controller 108 then determines whether a request for the generation of customized indicia has been received. In accordance with one embodiment of the subject application, the controller 108 prompts, via the user interface 106, the user 114 for initiation of a create an indicia operation. When no such request is received from the user 114, the controller 108 receives a requested document processing operation from the user 114 via the associated user interface 106. The controller 108 then directs the document processing device 104 to begin commencement of the requested document processing operation. In the event that the user 114 elects to generate a customized indicia corresponding to document processing operations, the controller 108 generates, via the associated user interface 106, indicia representing a first level of document processing operations, e.g., printing, scanning, copying, facsimile, electronic mail, electronic storage, or the like. The skilled artisan will appreciate that in accordance with one embodiment of the subject application, a first level operation includes a document retrieval from the storage server 116, an electronic storage operation with the storage location comprising the storage server 116, and the like.

The controller 108, via the user interface 106, then receives from the user 114 selection data corresponding to a desired first level document processing operation. Upon receipt of the user selection data, the controller 108 isolates a subset of second level document processing operations associated with the selected first level document processing operation. Upon ascertaining the subset of second level document processing operations corresponding to the previously selected first level operation, the controller 108 generates indicia representing the second level document processing operations via the associated user interface 106. The controller 108, via the user interface 106, then receives the selection of one or more second level document processing operations by the user 114. The controller 108 then determines whether any of the selected second levels of document processing operations have additional sublevels from which the user 114 is able to further make document processing selections, enable features, disable features, or the like.

When one or more of the second level document processing operations selected by the user 114 include additional sublevels of document processing features, functions, operations, options, or the like, which are capable of being modified by the user 114, the controller 108 isolates a subset of additional level operations corresponding to the second level operation with which it is associated. Indicia representative of this subset is then generated by the controller 108 via the associated user interface 106. The controller 108 then receives, via the user interface 106, the selection of the desired sublevel operation from the user 114. The controller 108 then determines whether a subset of additional levels, corresponding to the previously selected sublevels, is available for further user 114 input. The functioning and interaction of the user 114, controller 108, and the user interface 106 associated with the document processing device 104 continues until such time that the controller 108 determines no further sublevels remain for user 114 to modify.

Upon the determination that no additional sublevels are available, the controller 108 generates, via the user interface 106, a customized indicia corresponding to a commencement of a document processing operation inclusive of the all level user selection data. The customized indicia is then stored in association with the user identification data. Stated another way, the user 114 is presented with a set of icons, graphical representations, or the like via the user interface 106. The set of icons is preferably those icons associated with the selected operations, at all levels. Thus, the user 114 is presented only with those icons that correspond to one or more functions, features, or operations that the user 114 selected in generating the customized indicia. The user 114 then selects the desired icon to associate with the selected functions, operations, features, or the like. The skilled artisan will appreciate that as a result of the selection of a given icon as representative of a preset of operations, the user 114, to perform each operation, is now able to select that customized icon from a menu on the associated user interface 106, without making any further selections. Furthermore, the association between the identification data and the customized icon is stored in the data storage 110, whereupon any subsequent logins by the user 114 will result in the display of the customized icon.

It will be understood by those skilled in the art that the user 114 is capable of submitting such identification information remotely via the user device 120. Thus, the user 114 is able to remotely facilitate the generation of a customized indicia from the user device 120.

It will be understood by those skilled in the art that other components associated with the document processing device 104 are capable of functioning in the manner described herein with respect to the generation of customized indicia. Furthermore, the skilled artisan will appreciate that any hardware, software, or suitable combination thereof, associated with the document processing device 104, are capable of being implemented to facilitate the methodologies described in the subject application.

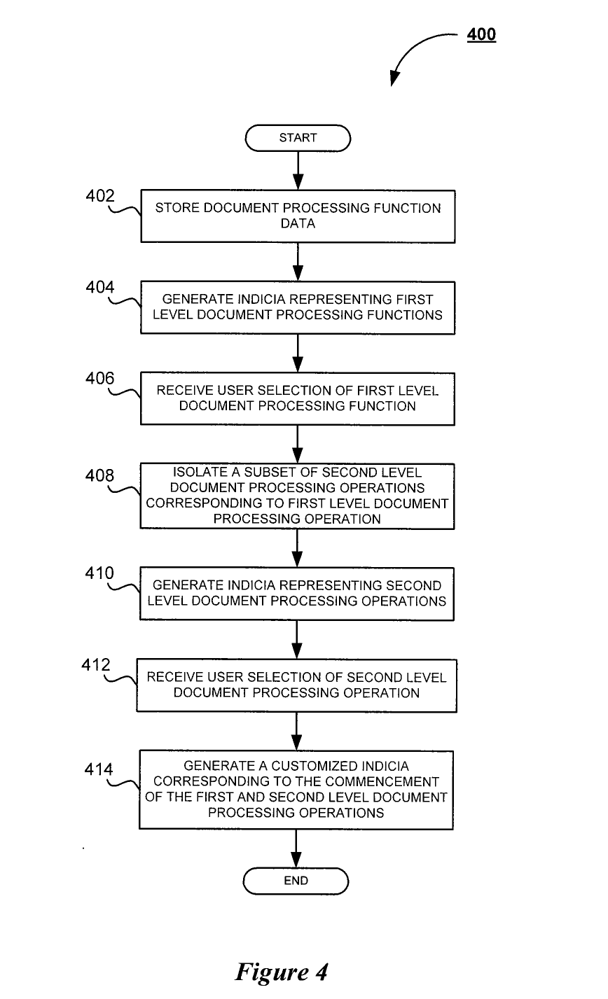

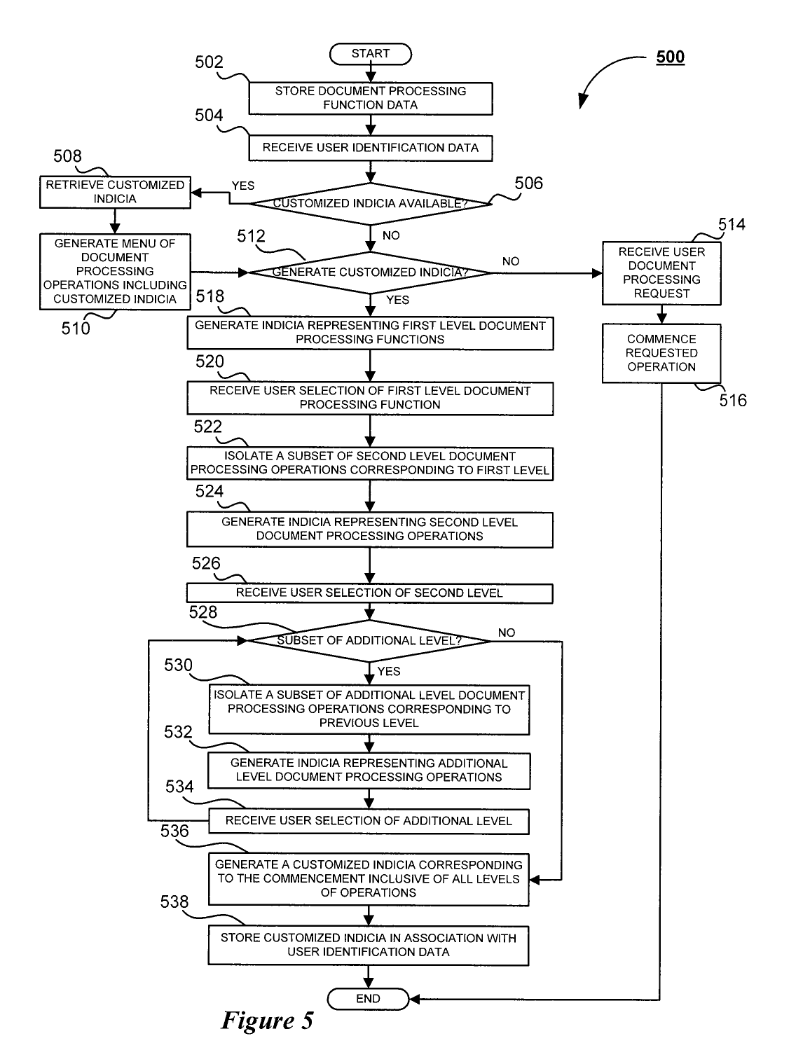

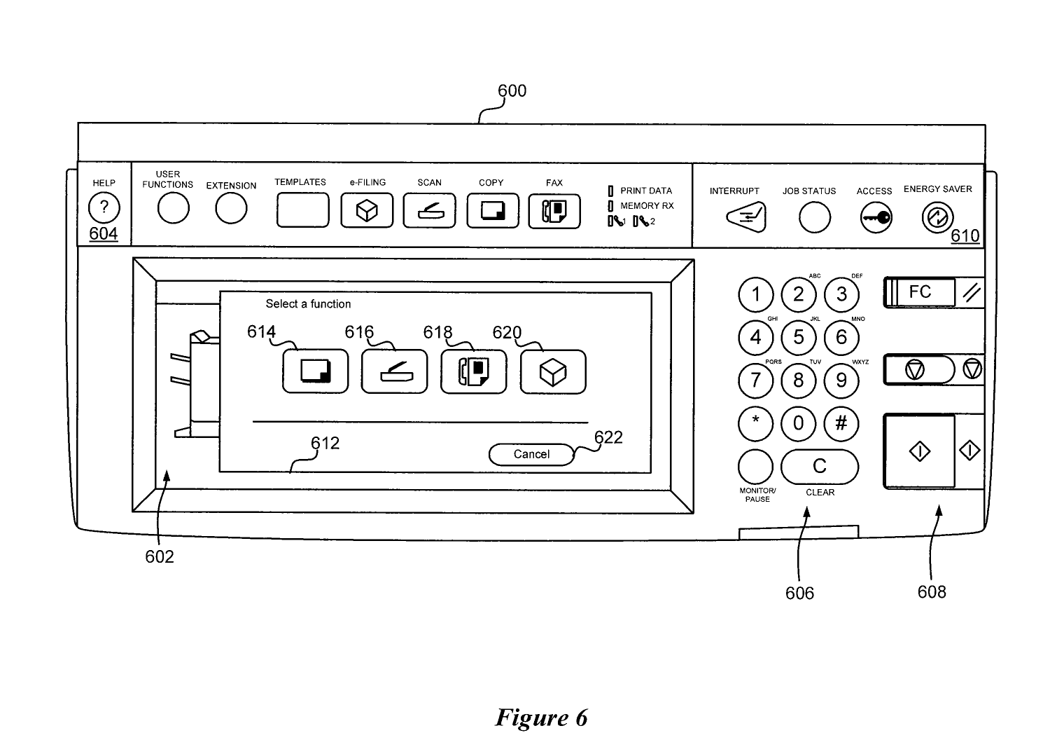

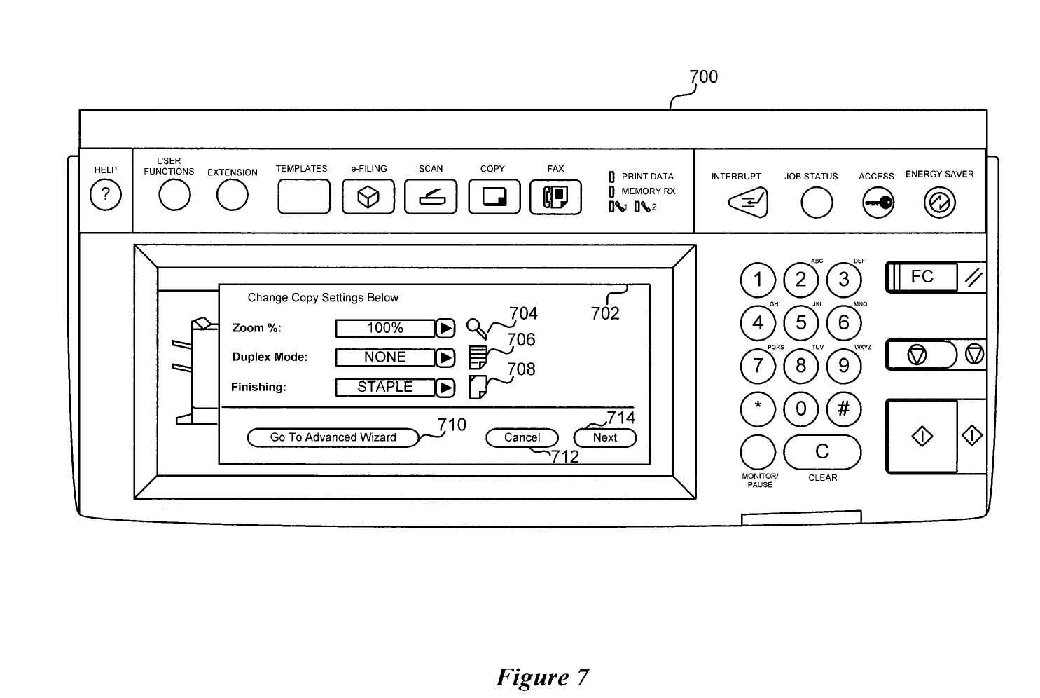

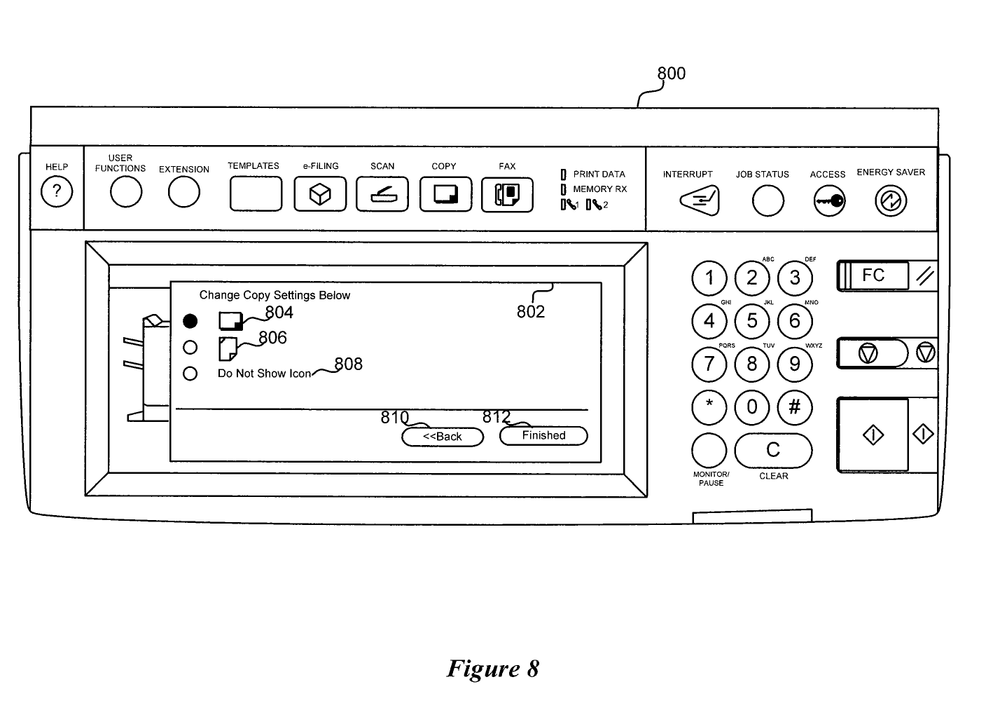

The foregoing system 100 and corresponding components described above in FIG. 1, FIG. 2, and FIG. 3, will better be understood when viewed in conjunction with the methodologies set forth in FIG. 4 and FIG. 5, as well as the screen templates illustrating a preferred embodiment of the subject application of FIG. 6, FIG. 7, and FIG. 8. Turning now to FIG. 4, there is shown a flowchart 400 illustrating a method for customizing a user interface for a document processing device in accordance with the subject application. Beginning at step 402, document processing function data is stored by the controller 108 associated with the document processing device 104. Preferably, this document processing function data is representative of the set of first level operations which the document processing device 104 is capable of performing. Suitable first level operations include, for example and without limitation, printing, scanning, copying, facsimile, electronic mail, electronic storage, or the like. The controller 108 then generates, at step 404, indicia representative of the first level document processing operations corresponding to the document processing function data. As mentioned above, the indicia is capable of including for example, and without limitation, data representative of an icon, a graphical representation, or the like, suitably adapted to denote a given operation or series of operations.

At step 406, the controller 108, via the associated user interface 106, receives user selection data representative of a selection by the user 114 of a first level document processing operation. For example, the selection data is capable of denoting the selection by the user 114 of a copy operation, a scan operation, a facsimile operation, a print operation, an electronic message/mail operation, an electronic storage, or the like. Using the received user selection data, the controller 108 then isolates, i.e., determines, at step 408 a subset of second level document processing operations corresponding to the received selection data. That is, the controller 108 determines the second level of functions or operations that are associated with the previously selected first level. For example, when the first level is a copy operation, the subset of second level operations is capable of including, for example and without limitation, finishing options, simplex/duplex, paper size, page orientation, or the like.

Once the subset of second level operations has been ascertained, the controller 108 generates indicia representative of these second level operations at step 410. The controller 108 then receives user selection data representative of the selection of second level operations by the user 114 via the associated user interface 106 at step 412. A customized indicia corresponding to the commencement of the first and second level document processing operations is then generated by the controller 108 at step 414.

Referring now to FIG. 5, there is shown a flowchart 500 illustrating a method for customizing a user interface for a document processing device in accordance with the subject application. Beginning at step 502, the controller 108 stores function data representative of the set of document processing functions capable of being performed by the associated document processing device 104. As discussed above, the function data corresponds to at least the first level document processing operations which the document processing device 104 is capable of commencing. At step 504 the controller 108 receives identification data representative of the identity of the user 114 via the associated user interface 106. In accordance with the preferred embodiment of the subject application, the associated user interface 106 is capable of including, for example and without limitation, a graphical user interface. The user identification data, as set forth above, includes, for example and without limitation, a password, a userID/password, biometric data, a PIN number, or the like.

A determination is then made at step 506 whether customized indicia is available. That is, the controller 108 uses the received identification data to first identify the identity of the user 114 and then to query the data storage device 110 to determine whether any customized indicia, or data corresponding thereto, is stored in the data storage device 110. Preferably, the indicia or data corresponding thereto, is stored in association with the user identification information, thereby enabling the controller 108 to locate such indicia or data using the identification data. When customized indicia is determined to be available, based upon data present in the data storage 110 indicating an association between customized indicia and the identified user 114, the customized indicia is retrieved from its storage location via any suitable means at step 508. At step 510 the controller 108 generates a menu, via the user interface 106, of document processing operations including the customized indicia. Preferably, such indicia is represented on the menu as an icon or other graphical representation.

Flow then proceeds to step 512, whereupon a determination is made whether the user 114 has elected to generate customized indicia. It will be appreciated that such a determination, as shown at step 512, occurs after retrieval of any previously generated customized indicia, as well as directly from step 506, upon the determination that no customized indicia is available. The determination made at step 512 is suitably based upon the submittal by the user 114 of a generate customized indicia request, as received by the controller 108. When no such request is received, i.e., the user 114 has not submitted such a request, flow proceeds to step 514, whereupon the controller 108 receives, via the user interface 106, a document processing request from the associated user 114. The requested operation is then commenced by the document processing device 104, at the direction of the controller 108, at step 516, whereupon the operation illustrated in FIG. 5 terminates.

Returning to step 512, when a positive determination is made by the controller 108, i.e., customization is selected, flow proceeds to step 518. At step 518, the controller 108 generates indicia representative of first level document processing operations, preferably corresponding to the function data. At step 520, the controller 108 receives, via the user interface 106, data representative of user first level selection data. That is, the controller 108 receives from the user 114 the user's selection of a first level document processing operation to be associated with a customized indicia. Flow then proceeds to step 522, whereupon a subset of second level document processing operations, associated with the previously selected first level operation, is isolated by the controller 108 via any suitable means known in the art. The controller 108 then generates, via the associated user interface 106, indicia representative of the subset of second level document processing operations at step 524. Second level selection data corresponding to the second level operations selected by the user 114 is then received by the controller 108 associated with the document processing device 104 at step 526.

At step 528, the controller 108 determines whether a subset of additional levels corresponding to the previously selected level, is available. That is, the controller 108 determines whether the selections made of the second level document processing operations include additional selections to be made. When such a determination, made at step 528, indicates that at least one additional sublevel remains for user 114 to modify, select, or the like, flow proceeds to step 530, whereupon the subset of additional levels corresponding to the previous level, e.g., the second level, is isolated by the controller 108 via any suitable means. Indicia representative of the additional sublevel document processing operations is then generated by the controller 108 in accordance with the subject application. The controller then receives the user 114 selection of the desired sublevel at step 534, whereupon flow returns to step 528.

At step 528, when the controller 108 determines that no additional level remains for user 114 to modify or select, flow proceeds to step 536, whereupon a customized indicia is generated corresponding to a commencement of a document processing operation inclusive of the selected levels, i.e., the first level selection data, the second level selection data, the sublevel selection data, or the like. The customized indicia is then stored in association with user identification data at step 538. Preferably, the association between the icon or graphical representation and the identification data is stored in the data storage device 110. Thus, the skilled artisan will appreciate that upon subsequent login attempts by the user 114, the customized indicia is generated as described above. Those skilled in the art will further appreciate that the customized indicia corresponds to data representative of an icon or graphical representation, the selection of which by the user 114 prompts the document processing device 104 to begin commencement of each first, second, and additional level of document processing operations.

Attention is now directed to the template user interfaces illustrated in FIG. 6, FIG. 7, and FIG. 8. The skilled artisan will appreciate that the template interfaces shown in FIGS. 6, 7, and 8 are for illustration purposes only, and are not intended to limit the subject application thereto. It will be understood by those skilled in the art that the overall hardware shown in FIGS. 6, 7, and 8 is the same, whereas the display changes in accordance with the selections made in the previous screen. Thus, discussion of the hardware aspects of FIG. 6 are applicable to the template interfaces 700 and 800 of FIG. 7 and FIG. 8, respectively. Beginning at FIG. 6, there is shown a first template 600 inclusive of a touchpanel or touchscreen display 602, a row of function buttons 604, an alphanumeric keypad 606, operative buttons 608, and secondary function buttons 610. Preferably, the function buttons 604 include, for example and without limitation, hardware buttons that enable a user 114 to quickly access a specific main document processing function, i.e., a first level function. The alphanumeric keypad 606 provides the user 114 with the ability to input numbers, letters, or the like, for example, a number of copies, a password, or the like. The operative buttons 608 include, for example and without limitation, a cancel button, a start button, or the like. In addition, the user interface 600 includes secondary function buttons 610, representative of functions and states of operation of the document processing device 104 not directly related to a given document processing operation, including, for example and without limitation, interrupt status, job status request, access (login), energy saver mode, or the like.

As depicted on the display 602, there is shown a dialog box 612 in which are the results of the indicia representative of the first level document processing functions shown to the user 114. That is, the copy icon 614, the scan icon 616, the facsimile icon 618, and the electronic message icon 620 correspond to a set of first level document processing functions generated by the controller 108 from the stored function data. The display 602 illustrates the output of the indicia, as viewed by the user 114. The dialog box 612 further includes a cancel icon 622, the selection of which exits the dialog box 612, thereby returning to the normal document processing operations of the document processing device 104. Thus, the user 114 is able to select a desired first level document processing function from among the icons 614-620, whereupon operations proceed to the next template 700. It will be appreciated by those skilled in the art that the selection of the desired function corresponds to a selection by the user 114 of the associated icon, a representation of which is stored in a set of available icons from which the user 114 will later choose the icon to represent the set of operations being selected. It will further be understood by the skilled artisan that other first level document processing operations are capable of being included in the dialog box 602, including a print icon (not shown), an electronic storage icon (not shown), or the like.

Turning now to FIG. 7, there is shown an updated dialog box 702, illustrating one or more second level document processing operations corresponding to a previous selection of the copy operation, i.e., selection of the copy icon 614. The dialog box 702 includes a zoom operation icon 704, a simplex/duplex mode selection icon 706, a finishing options selection icon 708, an advanced wizard selection icon 710, a cancel icon 712, and a next icon 714. As shown in FIG. 7, the zoom operation icon 704, shown as a magnifying glass, is set to 100%, indicating the user 114 has selected no zoom options. The simplex/duplex mode icon 706 is shown as a document with printing on one side, indicating a simplex mode of operation for the document processing device 104. The finishing options icon 708 is shown as a document having a staple, indicating that the user 114 has selected a finishing option corresponding to stapling the output document. The advanced wizard icon 710, as the skilled artisan will appreciate, prompts the user 114 to select additional options, features, operations, or the like consistent with the copy operation previously selected. Selection of the cancel icon 712 results in the display 602 returning to normal document processing operations, whereas the selection by the user 114 of the next icon 714 prompts the user 114 to select an icon to be associated with a commencement of the selected operations and/or features, as shown in FIG. 8.

It will be appreciated by those skilled in the art that as shown in FIG. 7, the user 114 has only indicated a staple finishing option, whereas the other options, i.e., zoom and simplex/duplex, remain normal. Thus, the icon associated with the selected option is added to the set of icons from which the user 114 will be able to select a desired icon representing the commencement of the selected operations and/or options.

Turning now to FIG. 8, there is shown a template user interface 800 depicting the final selection of the customized icon to be associated with the commencement of the selected document processing operations and/or features. The dialog box 802 suitably includes a visual display of the set of icons corresponding to the icons associated with the previously selected operations and/or options. Thus, shown in the dialog box 802 are the copy icon 804, the staple icon 806, and a do not show option 808. The dialog box 802 further includes a back icon 810, whereby the user 114 is able to return to the previous display 700, and a finished icon 812, whereby the selected icon is associated with the selected document processing operations and options and stored in association with received user 114 identification data in the associated data storage device 110. The user 114, shown in FIG. 8, has selected the copy icon 804 to be associated with the commencement of the selected copy operation with a finishing option of stapling. Thus, when the user 114 next logs onto the document processing device 104, a dialog box, such as that shown in FIG. 6, will display various icons corresponding to document processing operations, including the customized copy icon 804. When the user 114 selects the copy icon 804, the controller 108 will direct the document processing device 104 to perform a copy operation with the output document stapled.

The invention extends to computer programs in the form of source code, object code, code intermediate sources and partially compiled object code, or in any other form suitable for use in the implementation of the invention. Computer programs are suitably standalone applications, software components, scripts or plug-ins to other applications. Computer programs embedding the invention are advantageously embodied on a carrier, being any entity or device capable of carrying the computer program: for example, a storage medium such as ROM or RAM, optical recording media such as CD-ROM or magnetic recording media such as floppy discs. The carrier is any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the invention principles as described, will fall within the scope of the invention.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally and equitably entitled.

What is claimed:

1. A system for customizing a user interface for a document processing device comprising:
storage means adapted for storing function data representative of each of a plurality of document processing operations associated with a document processing device;
a display generator, the display generator including means adapted for generating, on an associated user interface, indicia representative of each of a plurality of first level of document processing operations on an associated user interface in accordance with the function data;
means adapted for receiving, from an associated user via the user interface, first document processing operation selection data representative of at least a selected one of the first level of document processing operations;
means adapted for isolating a subset of second level document processing operations corresponding to received document processing operation selection data;
the display generator further including means adapted for generating, on the user interface, indicia representative of each of the subset of secondary document processing operations;
means adapted for receiving, from an associated user via the user interface, second document processing selection data representative of at least a selected one of the second level of document processing operations; and
the display generator further including means adapted for generating, on the user interface, a customized indicia corresponding to a commencement of a document processing operation including the selected first and second level document processing operations.

2. The system for customizing a user interface for a document processing device of claim 1 wherein the customized indicia includes a visual indication of the first and second level document processing operations.

3. The system for customizing a user interface for a document processing device of claim 2 further comprising:
means adapted for receiving identification data representative of an identity of the associated user;
the display generator means further including means adapted for generating a menu of document processing operations corresponding to received identification data, which menu includes the customized indicia.

4. The system for customizing a user interface for a document processing device of 3 wherein the first level of document processing operations includes at least one of the group consisting of copying, scanning, facsimile transmission, printing, electronic mail, and electronic storage.

5. The system for customizing a user interface for a document processing device of claim 4 wherein the second level of document processing operations includes at least one of the group consisting of a zoom operation, a simplex/duplex operation, a paper orientation operation, a template generation operation, and a finishing operation.

6. The system for customizing a user interface for a document processing device of claim 5 wherein the finishing operation includes at least one of the group consisting of stapling, binding and hole punching.

7. The system for customizing a user interface for a document processing device of claim 3 wherein customized indicia is comprised of an icon including a visual representation of the first and second level document processing operations.

8. A method for customizing a user interface for a document processing device comprising the steps:
storing function data representative of each of a plurality of document processing operations associated with a document processing device;
generating, on an associated user interface, indicia representative of each of a plurality of first level of document processing operations on an associated user interface in accordance with the function data;
receiving, from an associated user via the user interface, first document processing operation selection data representative of at least a selected one of the first level of document processing operations;
isolating a subset of second level document processing operations corresponding to received document processing operation selection data;
generating, on the user interface, indicia representative of each of the subset of secondary document processing operations;
receiving, from an associated user via the user interface, second document processing selection data representative of at least a selected one of the second level of document processing operations; and
generating, on the user interface, a customized indicia corresponding to a commencement of a document processing operation including the selected first and second level document processing operations.

9. The method for customizing a user interface for a document processing device of claim 8 wherein the customized indicia includes a visual indication of the first and second level document processing operations.

10. The method for customizing a user interface for a document processing device of claim 9 further comprising:
receiving identification data representative of an identity of the associated user; and
generating a menu of document processing operations corresponding to received identification data, which menu includes the customized indicia.

11. The method for customizing a user interface for a document processing device of 10 wherein the first level of document processing operations includes at least one of the group consisting of copying, scanning, facsimile transmission, printing, electronic mail, and electronic storage.

12. The method for customizing a user interface for a document processing device of claim 11 wherein the second level of document processing operations includes at least one of the group consisting of a zoom operation, a simplex/duplex operation, a paper orientation operation, a template generation operation, and a finishing operation.

13. The method for customizing a user interface for a document processing device of claim 12 wherein the finishing operation includes at least one of the group consisting of stapling, binding and hole punching.

14. The method for customizing a user interface for a document processing device of claim 10 wherein customized indicia is comprised of an icon including a visual representation of the first and second level document processing operations.

15. A computer-implemented method for customizing a user interface for a document processing device comprising the steps:
storing function data representative of each of a plurality of document processing operations associated with a document processing device;
generating, on an associated user interface, indicia representative of each of a plurality of first level of document processing operations on an associated user interface in accordance with the function data;
receiving, from an associated user via the user interface, first document processing operation selection data representative of at least a selected one of the first level of document processing operations;
isolating a subset of second level document processing operations corresponding to received document processing operation selection data;
generating, on the user interface, indicia representative of each of the subset of secondary document processing operations;
receiving, from an associated user via the user interface, second document processing selection data representative of at least a selected one of the second level of document processing operations; and
generating, on the user interface, a customized indicia corresponding to a commencement of a document processing operation including the selected first and second level document processing operations.

16. The computer-implemented method for customizing a user interface for a document processing device of claim 9 further comprising:
receiving identification data representative of an identity of the associated user; and
generating a menu of document processing operations corresponding to received identification data, which menu includes the customized indicia.

17. The computer-implemented method for customizing a user interface for a document processing device of 16 wherein the first level of document processing operations includes at least one of the group consisting of copying, scanning, facsimile transmission, printing, electronic mail, and electronic storage.

18. The computer-implemented method for customizing a user interface for a document processing device of claim 17 wherein the second level of document processing operations includes at least one of the group consisting of a zoom operation, a simplex/duplex operation, a paper orientation operation, a template generation operation, and a finishing operation.

19. The computer-implemented method for customizing a user interface for a document processing device of claim 18 wherein the finishing operation includes at least one of the group consisting of stapling, binding and hole punching.

20. The computer-implemented method for customizing a user interface for a document processing device of claim 16 wherein customized indicia is comprised of an icon including a visual representation of the first and second level document processing operations.
